(19) United States
(12) Patent Application Publication
(10) Pub. No.: US 2018/0158346 A1
(43) Pub. Date: Jun. 7, 2018

(54) FLIGHT CONTROL METHOD AND FLIGHT CONTROL DEVICE

(71) Applicant: FUJITSU LIMITED, Kawasaki-shi (JP)

(72) Inventor: Makoto Goda, Warabi (JP)

(73) Assignee: FUJITSU LIMITED, Kawasaki-shi (JP)

(21) Appl. No.: 15/804,116

(22) Filed: Nov. 6, 2017

(30) Foreign Application Priority Data
Dec. 1, 2016 (JP) 2016-234471

(51) Int. Cl. G08G 5/04; G08G 5/00

(52) U.S. Cl. CPC G08G 5/045; G08G 5/0069; G08G 5/0021

(57) ABSTRACT

A flight control method that includes: by a processor, referring to a storage section that stores information related to flight control in association with airspace area, and acquiring information related to flight control corresponding to a specified airspace area; and controlling flight of a subject device based on the acquired information related to flight control.

### CROSS-REFERENCE TO RELATED APPLICATION

This application is based upon and claims the benefit of priority of the prior Japanese Patent Application No. 2016-234471, filed on Dec. 1, 2016, the entire contents of which are incorporated herein by reference.

### FIELD

The embodiments discussed herein are related to a flight control method, a recording medium storing a flight control program, and a flight control device.

### BACKGROUND

An autonomous flying robot that flies while following a moving object in a state of separation from the moving object by a specific distance is known.

Further, a navigation method for an unmanned aircraft is known that, in cases in which an obstacle has been detected while flying according to a first flight plan, computes a second flight plan to avoid the detected obstacle.

### Related Patent Documents

Patent Document 1: Japanese Laid-Open Patent Publication No. 2014-119828

Patent Document 1: Japanese Laid-Open Patent Publication No. 2010-095246

### SUMMARY

According to an aspect of the embodiment, a flight control method comprising: by a processor, referring to a storage section that stores information related to flight control in association with airspace area, and acquiring information related to flight control corresponding to a specified airspace area; and controlling flight of a subject device based on the acquired information related to flight control.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a schematic configuration of a flying object according to an exemplary embodiment.

FIG. 2 is a functional block diagram of a flight control device according to an exemplary embodiment.

FIG. 3 is a perspective view for explaining blocks and voxels.

FIG. 4 is a perspective view for explaining an example of prescribed travel directions corresponding to altitudes of voxels.

FIG. 5 is a plan view illustrating an example of travel directions of flying objects in a first voxel layer.

FIG. 6 is a plan view illustrating an example of travel directions of flying objects in a second voxel layer.

FIG. 7 is a plan view illustrating an example of travel directions of flying objects in a third voxel layer.

FIG. 8 is a plan view illustrating an example of travel directions of flying objects in a fourth voxel layer.

FIG. 9 is a plan view illustrating an example of a flight path of a flying object proceeding straight ahead in an eastward direction and then changing travel direction to a northward direction.

FIG. 10 is a diagram illustrating an example of reference data.

FIG. 11 is a diagram illustrating an example of self-device information.

FIG. 12 is a diagram illustrating an example of other-device information.

FIG. 13 is a diagram illustrating an example of exclusion information.

FIG. 14 is a diagram illustrating an example of destination information.

FIG. 15 is a diagram illustrating an example of target block information.

FIG. 16 is a diagram illustrating an example of direction change information.

FIG. 17 is a block diagram illustrating a schematic configuration of a computer that functions as a flight control device according to an exemplary embodiment.

FIG. 18 is a flowchart illustrating an example of flight control processing according to an exemplary embodiment.

FIG. 19 is a flowchart illustrating an example of flight path determination processing according to an exemplary embodiment.

FIG. 20A and FIG. 20B are a flowchart illustrating an example of direction change control processing according to an exemplary embodiment.

FIG. 21 is a flowchart illustrating an example of high-speed-region entry confirmation processing according to an exemplary embodiment.

FIG. 22 is a flowchart illustrating an example of high-speed flight control processing according to an exemplary embodiment.

FIG. 23 is a flowchart illustrating an example of collision avoidance processing according to an exemplary embodiment.

### DESCRIPTION OF EMBODIMENTS

An example of an exemplary embodiment of technology disclosed herein is described in detail below, with reference to the drawings.

First, configuration of a flying object 10 according to the present exemplary embodiment is described, with reference to FIG. 1. As illustrated in FIG. 1, the flying object 10 includes a flight control device 12, plural (for example, 4) propellers 14, and a global positioning system (GPS) receiver 16.

Each propeller 14 is present in the same plane, and the rotational speed of each propeller 14 is controlled individually under control of the flight control device 12. Accordingly, the flight control device 12 can control flight of the flying object 10 by controlling the rotational speed of each propeller 14 individually.

The GPS receiver 16 receives a signal from three or more GPS satellites in order to determine position information related to the current position of the flying object 10 (for example, the latitude, longitude, and altitude of the current position of the flying object 10), and the GPS receiver 16 outputs the determined position information to the flight control device 12. Note that another device capable of identifying position information of the flying object 10 may be employed instead of the GPS receiver 16.

Further, the flying object 10 exchanges various information with other flying objects 18 by wireless communication. Further, the flying object 10 exchanges various information with a server 22 through a network 20 using wireless communication. Note that the configuration of the other flying objects 18 is similar to the configuration of the flying object 10.

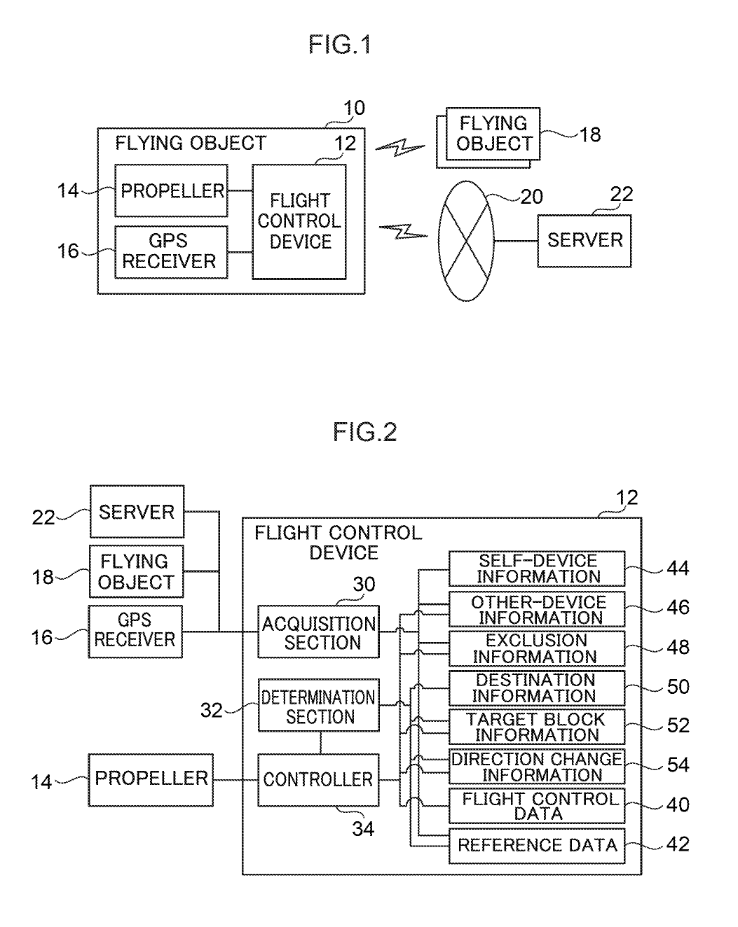

Next, a functional configuration of the flight control device 12 according to the present exemplary embodiment is described, with reference to FIG. 2. As illustrated in FIG. 2, the flight control device 12 includes an acquisition section 30, a determination section 32, and a controller 34. Further, flight control data 40, reference data 42, self-device information 44, other-device information 46, exclusion information 48, destination information 50, target block information 52, and direction change information 54 are stored in a specific storage region of the flight control device 12. (A self-device is an example of a subject device.)

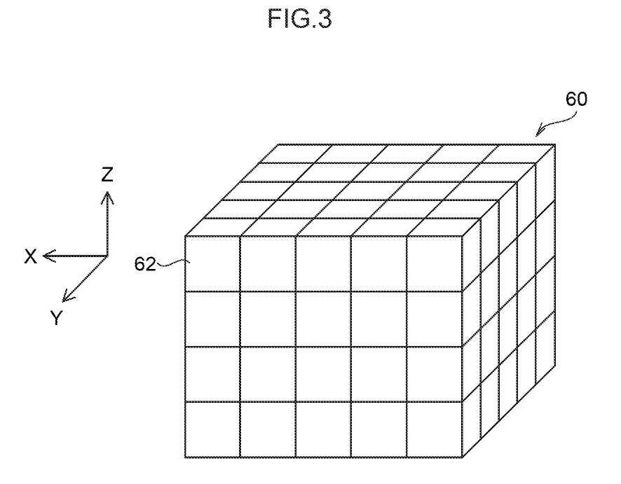

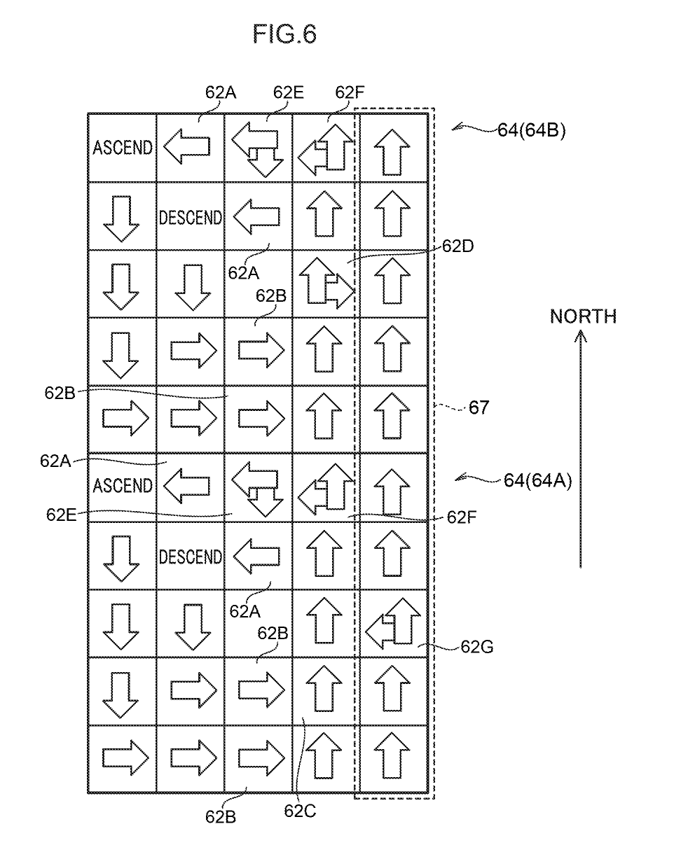

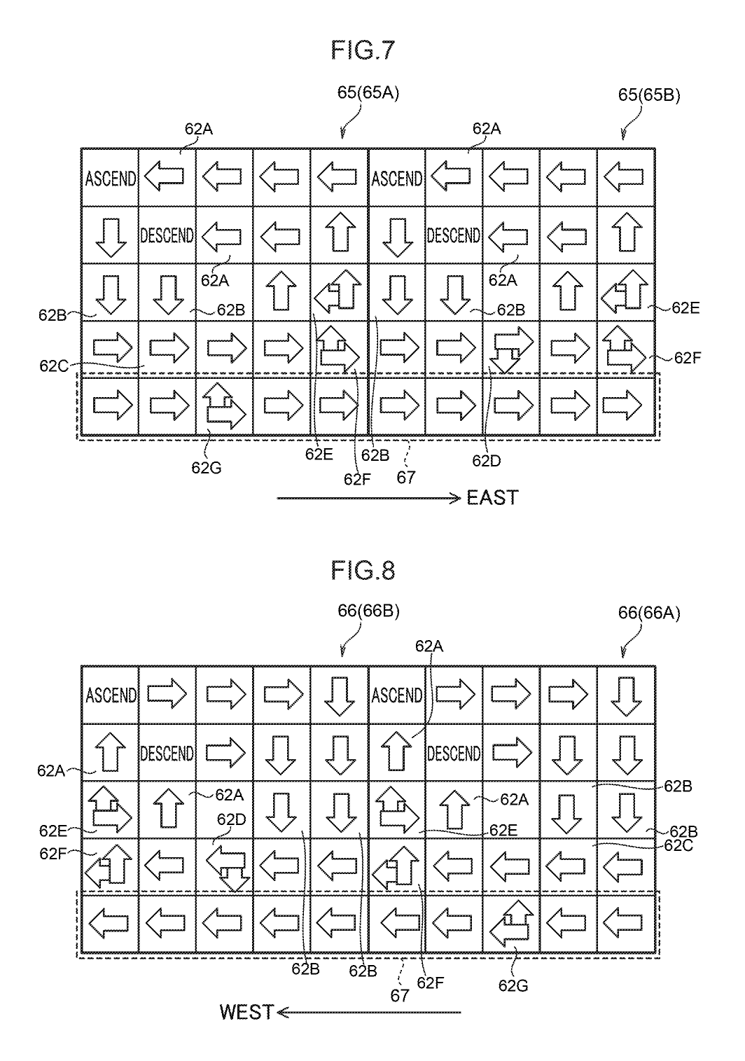

Information related to flight control of the flying object 10 (referred to as “flight control information” hereafter) is stored in the flight control data 40 in association with airspace area. Note that the flight control data 40 is pre-stored in a specific storage region of the flight control device 12. The flight control data 40 is described with reference to FIG. 3 to FIG. 9.

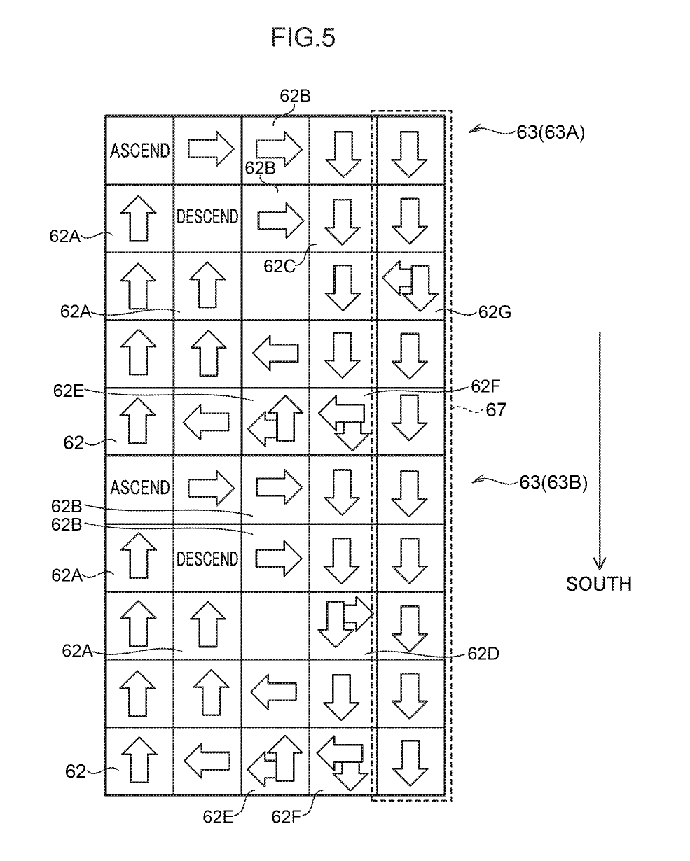

As illustrated in FIG. 3, flight control information is stored in the flight control data 40 for respective voxels 62 of blocks 60 that includes plural voxels 62. In the present exemplary embodiment, each block 60 includes the voxels 62 arrayed such that there are five voxels along one predetermined horizontal direction (for example, the x-axis direction of FIG. 3), five voxels along a direction orthogonal to the one direction (for example, the y-axis direction of FIG. 3), and four voxels along a vertical direction (the z-axis direction of FIG. 5). Further, in the present exemplary embodiment, each voxel 62 is a cube having side lengths of 5 m. Note that the shape of the voxels 62, the length of each edge, and the number of voxels 62 included in the block 60 are obviously not limited to the example illustrated in FIG. 3.

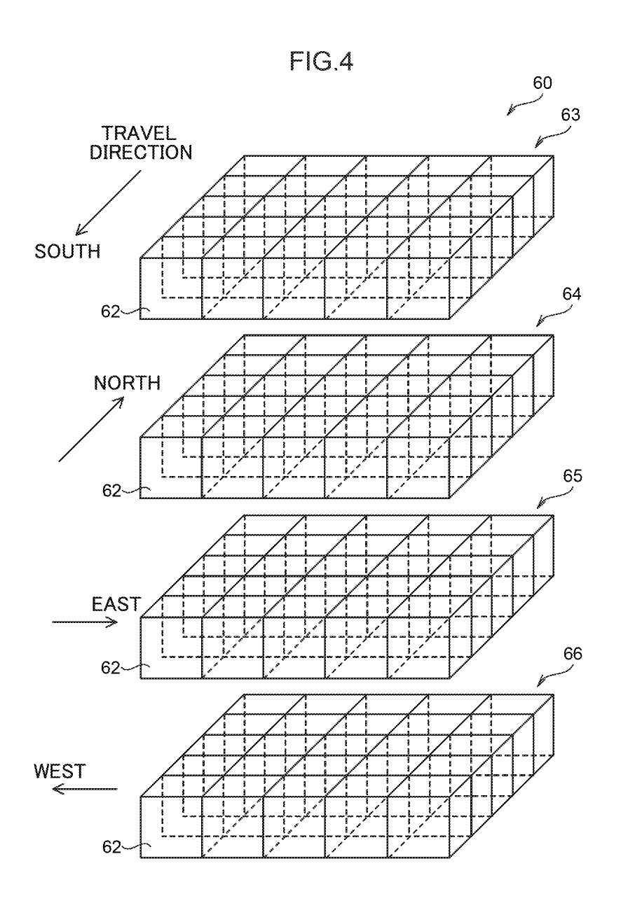

Further, as illustrated in FIG. 4, the travel direction of the flying object is predetermined according to the altitude of the voxel 62. Hereafter, the first voxel 62 group from the top of the block 60 is referred to as a first voxel layer 63, and the second voxel 62 group from the top of the block 60 is referred to as a second voxel layer 64. Further, hereafter, the third voxel 62 group from the top of the block 60 is referred to as a third voxel layer 65, and the fourth voxel 62 group from the top of the block 60 is referred to as a fourth voxel layer 66.

Further, as an example, a case is described below in which the prescribed travel direction corresponding to the altitude of the first voxel layer 63 is a southward direction, and the prescribed travel direction corresponding to the altitude of the second voxel layer 64 is a northward direction. Further, as an example, a case is described below in which the prescribed travel direction corresponding to the altitude of the third voxel layer 65 is an eastward direction and the prescribed travel direction corresponding to the altitude of the fourth voxel layer 66 is a westward direction.

Namely, in the present exemplary embodiment, when the flying objects 10 and 18 fly toward the north, they fly at an altitude corresponding to the first voxel layer 63, and when flying toward the south, they fly at an altitude corresponding to the second voxel layer 64. Further, in the present exemplary embodiment, when the flying objects 10 and 18 fly toward the east they fly at an altitude corresponding to the third voxel layer 65, and fly at an altitude corresponding to the fourth voxel layer 66 when flying toward the west.

As illustrated in FIG. 5 to FIG. 8, in the flight control data 40, one or plural (two in the examples of FIG. 5 to FIG. 8) travel directions are stored as flight control information in association with each of the plural voxels 62 mesh-partitioning the block 60. Note that the arrows in FIG. 5 to FIG. 8 indicate the travel direction of the flying object 10 in each voxel 62. Further, the voxels 62 containing “ascend” indicate that the flying object 10 travels in an ascending direction, and voxels 62 containing “descend” indicate that the flying object travels in a descending direction.

Further, the positions of the “ascend” voxels 62 and the “descend” voxels 62 are at the same positions in each voxel layer out of the first voxel layer 63, the second voxel layer 64, the third voxel layer 65, and the fourth voxel layer 66. Further, a region 67 in each voxel layer is a region in which the flying object 10 flies when traveling in a prescribed direction corresponding to that voxel layer.

When flying in the region 67, the flying object 10 according to the present exemplary embodiment flies at a top speed defined by design specifications, legislation, and the like, and, when flying in voxels 62 in regions other than the region 67, flies at a slower speed than the flying speed in the region 67 so as to be able to change travel direction.

Further, letters of the alphabet are appended as suffixes to the reference numerals of the voxels 62 when distinguishing from other voxels 62 in the description below. A voxel 62A is a voxel through which the flying object 10 flies immediately before entering an “ascend” voxel 62 or a “descend” voxel 62. A voxel 62B is a voxel through which the flying object 10 flies after leaving an “ascend” voxel 62 or a “descend” voxel 62, and immediately before entering a voxel 62 adjacent to a voxel 62 of the region 67.

A voxel 62G is a voxel for the flying object 10 to change travel direction in when exiting from the region 67. A voxel 62C is a voxel diagonally to the rear of the voxel 62G with respect to the travel direction of the region 67. A voxel 62D is a voxel in which the flying object 10 changes travel direction immediately before entering the region 67. A voxel 62E is a voxel in which the flying object 10 selects a travel direction depending on whether the flying object 10 is to ascend or to descend. A voxel 62F is a voxel, other than a voxel 62 in the region 67, from which it is possible to enter a block 60 adjacent in the region 67 travel direction.

Further, in each voxel layer, two types of voxel layer adjacent in the region 67 travel direction are treated as a pair. Note that when distinguishing between the two types of voxel layer in the description below, reference numerals for voxel layers including the voxel 62G are allocated the suffix “A”, and reference numerals for voxel layers including the voxel 62D are allocated the suffix “B”.

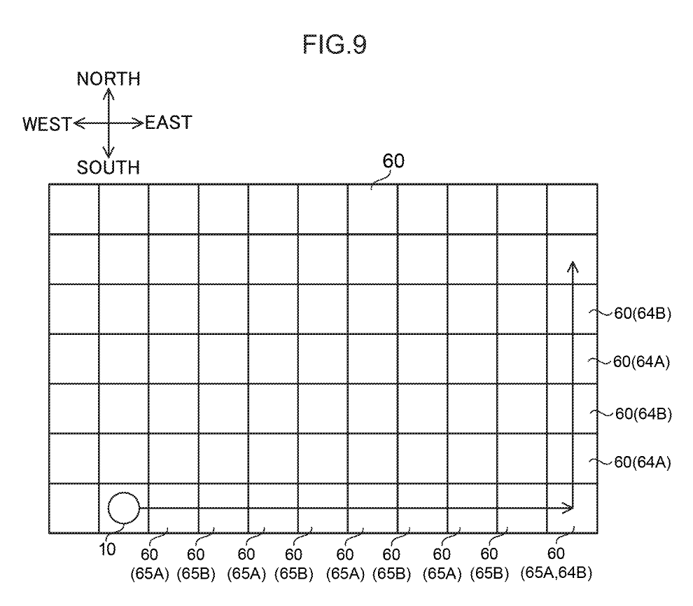

The flying object 10 flies according to the travel direction associated with each voxel 62. Accordingly, when the flying object 10 proceeds straight ahead in the eastward direction and then changes direction to proceed straight ahead in a northward direction, the flying object 10, for example, proceeds straight ahead through the region 67 of the third voxel layers 65A and 65B, as illustrated in FIG. 9. Further, in the voxel 62G for changing travel direction in the third voxel layer 65A of the block 60, the flying object 10 leaves the region 67 and flies toward an “ascend” voxel 62. The flying object 10 then ascends in the “ascend” voxel 62 to an altitude corresponding to the second voxel layer 64B, and then passes through the voxel 62D of the second voxel layer 64B and enters the region 67 of the second voxel layer 64B. Then, the flying object 10 proceeds straight ahead through the region 67 of the second voxel layers 64A and 64B.

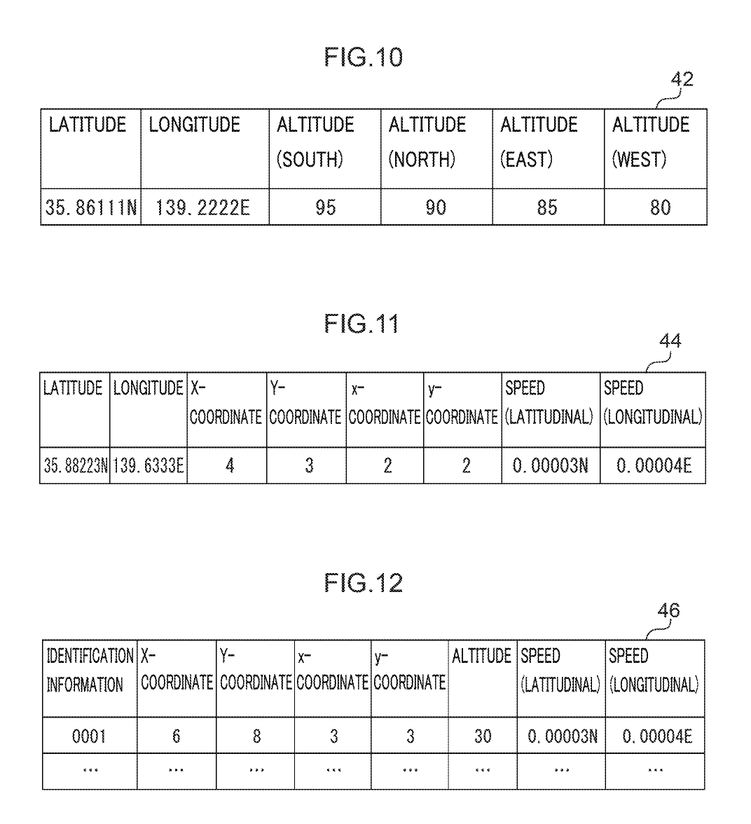

Information serving as references for the positions of the block 60, the voxel 62, the flying objects 10 and 18, and the like is stored in the reference data 42. FIG. 10 illustrates an example of the reference data 42. As illustrated in FIG. 10, a latitude, a longitude, an altitude (south), an altitude (north), an altitude (east), and an altitude (west) are stored in the reference data 42. A latitude and longitude serving as a reference for the position of the blocks 60, the voxels 62, the flying objects 10 and 18, and the like, as described later, are stored as the latitude and longitude. Minimum values of altitude (m) when the flying object 10 proceeds straight ahead in each direction out of east, west, south, and north are stored as the altitude (south), altitude (north), altitude (east), and altitude (west). Note that in the present exemplary embodiment, the reference data 42 is pre-stored in a specific storage region of the flight control device 12.

Namely, in the present exemplary embodiment, the flying object 10 flies at an altitude of 95 m or greater but less than 100 m when proceeding straight ahead in the southward direction, namely, when flying through the first voxel layer 63. Further, the flying object 10 flies at an altitude of 90 m or greater but less than 95 m when proceeding straight ahead in the northward direction, namely, when flying through the second voxel layer 64. Further, the flying object 10 flies at an altitude of 85 m or greater but less than 90 m when proceeding straight ahead in the eastward direction, namely, when flying through the third voxel layer 65. Further, the flying object 10 flies at an altitude of 80 m or greater but less than 85 m when proceeding straight ahead in the westward direction, namely, when flying through the fourth voxel layer 66.

Information related to the current position of the flying object 10 itself is stored in the self-device information 44. FIG. 11 illustrates an example of the self-device information 44. As illustrated in FIG. 11, a latitude, a longitude, an X-coordinate, a Y-coordinate, an x-coordinate, a y-coordinate, a speed (latitudinal), and a speed (longitudinal) are stored in the self-device information 44. The latitude of the current position of the flying object 10 is stored as the latitude. The longitude of the current position of the flying object 10 is stored as the longitude. A coordinate in the east-west direction of the block 60 corresponding to the latitude and the longitude of the self-device information 44, with reference to the block 60 corresponding to the latitude and longitude of the reference data 42, is stored as the X-coordinate. Examples of the X-coordinate include the number of blocks 60 present along the east-west direction from the block 60 corresponding to the latitude and longitude of the reference data 42 until the block 60 corresponding to the latitude and longitude of the self-device information 44. Further, an example of the value of this coordinate includes an example in which a positive sign is assigned to blocks 60 in the eastward direction from the block 60 corresponding to the latitude and longitude of the reference data 42, and a negative sign is assigned to blocks 60 in the westward direction from the block 60 corresponding to the latitude and longitude of the reference data 42.

A south-north direction coordinate of the block 60 corresponding to the latitude and longitude of the self-device information 44, with reference to the block 60 corresponding to the latitude and longitude of the reference data 42, is stored as the Y-coordinate. Examples of the Y-coordinate include the number of blocks 60 present along the south-north direction from the block 60 corresponding to the latitude and longitude of the reference data 42 until the block 60 corresponding to the latitude and longitude of the self-device information 44. Further, an example of the value of this coordinate includes an example in which a positive sign is assigned to blocks 60 in the northward direction of the block 60 corresponding to the latitude and longitude of the reference data 42, and a negative sign is assigned to blocks 60 in the southward direction of the block 60 corresponding to the latitude and longitude of the reference data 42.

An east-west direction coordinate within the block 60 of the voxel 62 corresponding to the latitude and longitude of the self-device information 44 is stored as the x-coordinate. A south-north direction coordinate within the block 60 of the voxel 62 corresponding to the latitude and longitude of the self-device information 44 is stored as the y-coordinate. Examples of the x-coordinate include the number of voxels 62 present along the east-west direction from a predetermined voxel 62 within the block 60 (for example, the voxel 62 at the south-west end portion thereof) until the voxel 62 corresponding to the latitude and longitude of the self-device information 44. Examples of the y-coordinate include the number of voxels 62 present along the south-north direction from the predetermined voxel 62 within the block 60 until the voxel 62 corresponding to the latitude and longitude of the self-device information 44.

A movement amount of the flying object 10 along the south-north direction per unit of time is stored as the speed (latitudinal). A movement amount of the flying object 10 along the east-west direction per unit of time is stored as the speed (longitudinal). The speed (latitudinal) and the speed (longitudinal) are, for example, employed to distinguish between travel directions of the flying object 10.

Information relating to the current positions of other flying objects 18 is stored in the other-device information 46. FIG. 12 illustrates an example of the other-device information 46. As illustrated in FIG. 12, identification information, an X-coordinate, a Y-coordinate, an x-coordinate, a y-coordinate, an altitude, a speed (latitudinal), and a speed (longitudinal) are stored in the other-device information 46. Information uniquely identifying a flying object 18 is stored as the identification information. Similarly to in the self-device information 44, coordinates of the block 60 corresponding to the current position of the flying object 18, with reference to the latitude and longitude of the reference data 42, are stored as the X-coordinate and the Y-coordinate. Similarly to the self-device information 44, coordinates within the block 60 of the voxel 62 corresponding to the current position of the flying object 18 are stored as the x-coordinate and the y-coordinate. The altitude (m) of the current position of the flying objects 18 is stored as the altitude. Similarly to the self-device information 44, the speed of the flying object 18 is stored as the speed (latitudinal) and the speed (longitudinal).

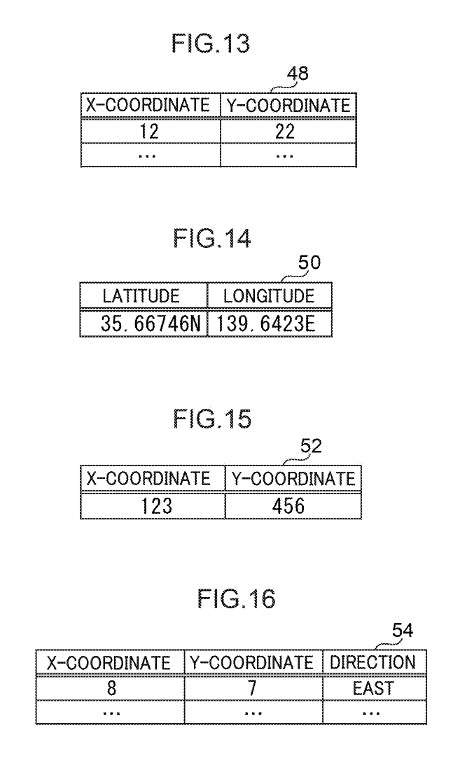

For example, information related to any block 60 that the flying object 10 is excluded from, because of reasons such as there being an obstacle such as a building present, is stored as the exclusion information 48. FIG. 13 illustrates an example of the exclusion information 48. As illustrated in FIG. 13, an X-coordinate and a Y-coordinate for each block 60 that the flying object 10 is excluded from, with reference to the block 60 corresponding to the latitude and longitude of the reference data 42, are stored as the exclusion information 48.

Information related to the position of the flight destination of the flying object 10 is stored as the destination information 50. FIG. 14 illustrates an example of the destination information 50. As illustrated in FIG. 14, the latitude and longitude of the destination are stored as the destination information 50.

Information related to a block 60 corresponding to the position of the flight destination of the flying object 10 is stored as the target block information 52. FIG. 15 illustrates an example of the target block information 52. As illustrated in FIG. 15, the X-coordinate and Y-coordinate of the block 60 corresponding to the latitude and longitude of the destination stored as the destination information 50, with reference to the block 60 corresponding to the latitude and longitude of the reference data 42, is stored as the target block information 52.

Information related to blocks 60 for the flying object 10 to change travel direction in between a departure point and the destination is stored as the direction change information 54. FIG. 16 illustrates an example of the direction change information 54. As illustrated in FIG. 16, the X-coordinate and the Y-coordinate of the block 60 for the flying object 10 to change travel direction in, with reference to the block 60 corresponding to the latitude and longitude of the reference data 42, is stored as the direction change information 54. Further, the travel direction of the flying object 10 after changing travel direction is also stored as the direction change information 54.

The acquisition section 30 acquires the latitude, longitude, and altitude of the current position of the flying object 10 from the GPS receiver 16. The acquisition section 30 then stores the acquired latitude and longitude as the latitude and longitude of the self-device information 44. Further, the acquisition section 30 computes a south-north direction speed by taking a value obtained by subtracting the previously acquired latitude from the latitude acquired this time, and dividing this value by a value obtained by subtracting the time the previous latitude was acquired from the time the current latitude was acquired. The acquisition section 30 then stores the computed south-north direction speed as the speed (latitudinal) of the self-device information 44.

Further, the acquisition section 30 computes an east-west direction speed by taking a value obtained by subtracting the previously acquired longitude from the longitude acquired this time, and dividing this value by a value obtained by subtracting the time the previous longitude was acquired from the time the current longitude was acquired. The acquisition section 30 then stores the computed east-west direction speed as the speed (longitudinal) of the self-device information 44.

Further, the acquisition section 30 computes the east-west direction coordinates of the block 60 corresponding to the acquired latitude and longitude, with reference to the block 60 corresponding to the latitude and longitude of the reference data 42. The acquisition section 30 then stores the computed east-west direction coordinates as the X-coordinate of the self-device information 44. Further, the acquisition section 30 computes the south-north direction coordinates of the block 60 corresponding to the acquired latitude and longitude, with reference to the block 60 corresponding to the latitude and longitude of reference data 42. The acquisition section 30 then stores the computed south-north direction coordinate as the Y-coordinate of the self-device information 44.

Further, based on the latitude and longitude of the reference data 42 and the acquired latitude and longitude, the acquisition section 30 computes the east-west direction coordinates within the block 60 of the voxel 62 corresponding to the acquired latitude and longitude. The acquisition section 30 then stores the computed east-west direction coordinates as the x-coordinate of the self-device information 44. Further, based on the latitude and longitude of the reference data 42 and the acquired latitude and longitude, the acquisition section 30 computes the south-north direction coordinate within the block 60 of the voxel 62 corresponding to the acquired latitude and longitude. The acquisition section 30 then stores the computed south-north direction coordinate as the y-coordinate of the self-device information 44.

Further, the acquisition section 30 acquires various information from any other flying object 18 present in a communicable range. In the present exemplary embodiment, the acquisition section 30 acquires, from each of the flying objects 18, identification information uniquely identifying the flying object 18 and the east-west direction coordinate and south-north direction coordinate thereof, with reference to the block 60 corresponding to the latitude and longitude of the reference data 42 of the block 60 corresponding to the current position of the other flying object 18. The acquisition section 30 then stores the acquired identification information as the identification information of the other-device information 46. Further, the acquisition section 30 stores the acquired east-west direction coordinates as the X-coordinate of the other-device information 46 and stores the acquired south-north direction coordinate as the Y-coordinate of the other-device information 46.

Further, the acquisition section 30 acquires, from the other flying object 18, the east-west direction coordinate and south-north direction coordinate thereof within the block 60 of the voxel 62 corresponding to the current position of the other flying object 18. The acquisition section 30 then stores the acquired east-west direction coordinate as the x-coordinate of the other-device information 46 and stores the acquired south-north direction coordinate the y-coordinate of the other-device information 46.

Further, the acquisition section 30 acquires, from the other flying object 18, the altitude of the current position of the flying object 18. Further, the acquisition section 30 acquires, from the other flying object 18, the south-north direction speed and the east-west direction speed of the flying object 18. The acquisition section 30 then stores the acquired altitude as altitude in the other-device information 46. Further, the acquisition section 30 stores the acquired south-north direction speed as the speed (latitudinal) of the other-device information 46 and stores the acquired east-west direction speed as speed (longitudinal) in the other-device information 46.

Further, the acquisition section 30 acquires, from the server 22, the X-coordinate and Y-coordinate of any block 60 that the flying object 10 is excluded from, with reference to the block 60 corresponding to the latitude and longitude of the reference data 42. The acquisition section 30 then stores the acquired X-coordinates as X-coordinates in the exclusion information 48 and stores the acquired Y-coordinates as Y-coordinates in the exclusion information 48.

Further, the acquisition section 30 acquires the latitude and longitude of the flight destination of the flying object 10 input by a user via a terminal or the like. The acquisition section 30 then stores the acquired latitude as the latitude of the destination information 50 and stores the acquired longitude as the longitude of the destination information 50.

Further, the acquisition section 30 computes the east-west direction coordinate of the block 60 corresponding to the acquired latitude and longitude of the destination, with reference to the block 60 corresponding to the latitude and longitude of the reference data 42. Further, the acquisition section 30 computes the south-north direction coordinate of the block 60 corresponding to the latitude and longitude of the acquired destination, with reference to the block 60 corresponding to the latitude and longitude of the reference data 42. The acquisition section 30 then stores the computed east-west direction coordinate as the X-coordinate of the target block information 52 and stores the computed south-north direction coordinate as the Y-coordinate of the target block information 52.

Further, the acquisition section 30 refers to the flight control data 40, and acquires the travel direction of the flying object 10 stored in association with the voxel 62 corresponding to the current position of the flying object 10.

The determination section 32 refers to the self-device information 44, the exclusion information 48, and the target block information 52, and determines a flight path for the flying object 10. In the present exemplary embodiment, from out of paths from the current position of the flying object 10 to the destination of the flying object 10, the determination section 32 determines, as the flight path for the flying object 10, a shortest path that avoids the blocks 60 that the flying object 10 is excluded from, and that is also the path with the smallest number of changes to travel direction for the flying object 10. The determination section 32 then stores the travel direction for the flying object 10 after changing travel direction, as the direction in the direction change information 54 for blocks 60 on the determined flight path in which the flying object 10 will change travel direction.

Further, the determination section 32 computes the east-west direction coordinate of the blocks 60 on the determined flight path in which the flying object 10 will change travel direction, with reference to the block 60 corresponding to the latitude and longitude of the reference data 42. Further, the determination section 32 computes the south-north direction coordinates of the blocks 60 on the determined flight path in which the flying object 10 will change travel direction, with reference to the block 60 corresponding to the latitude and longitude of the reference data 42. The determination section 32 then stores the computed east-west direction coordinates as the X-coordinates of the direction change information 54 and stores the computed south-north direction coordinates as the Y-coordinates of the direction change information 54.

The controller 34 controls the flight of the flying object 10 over the distance of one voxel 62 in accordance with the travel direction acquired by the acquisition section 30. Further, when there are plural travel directions associated with the voxel 62 corresponding to the current position of the flying object 10, the controller 34 selects the travel direction of the flying object 10 in accordance with the travel direction of the flight path determined by the determination section 32.

Further, in cases in which there are plural travel directions associated with the voxel 62 corresponding to the current position of the flying object 10, from out of the plural travel directions, the controller 34 selects a travel direction that enables collisions to be avoided in accordance with a detected direction of the other flying objects 18. For example, in cases in which the current position of the flying object 10 is within a region of the voxel 62F, if another flying object 18 is present in the voxel 62E adjacent to the voxel 62F, the controller 34 selects the direction that differs from the direction heading toward the voxel 62E. Further, the controller 34 effects control so as to hover the flying object 10 for a specific duration in cases in which another flying object 18 is present in the voxel 62 that the flying object 10 will enter next.

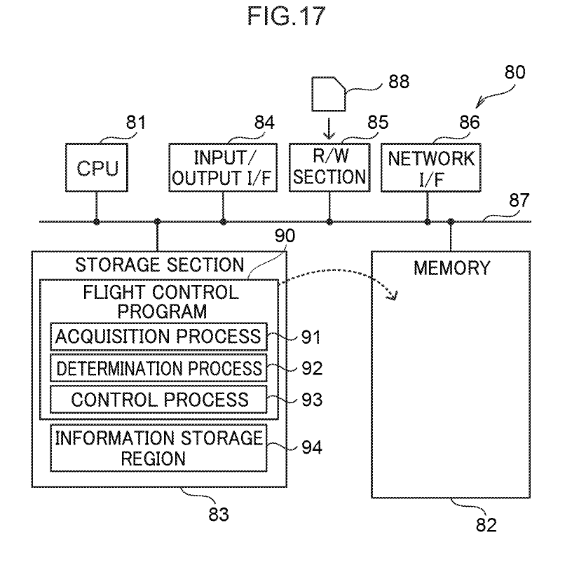

The flight control device 12 may, for example, be implemented by the computer 80 illustrated in FIG. 17. The computer 80 includes a central processing unit (CPU) 81, memory 82 serving as a temporary storage region, and a non-volatile storage section 83. Further, the computer 80 includes an input/output I/F 84 to which the GPS receiver 16 and the like are connected. Further, the computer 80 includes a read/write (R/W) section 85 that controls reading and writing of data from and to a recording medium 88, and a network I/F 86 connected to the network. The CPU 81, the memory 82, the storage section 83, the input/output I/F 84, the R/W section 85, and the network I/F 86 are connected to one another via a bus 87.

The storage section 83 may be implemented by a hard disk drive (HDD), a solid state drive (SSD), flash memory, or the like. A flight control program 90 for causing the computer 80 to function as the flight control device 12 is stored in the storage section 83, which serves as a storage medium. The flight control program 90 includes an acquisition process 91, a determination process 92, and a control process 93. Further, the storage section 83 includes an information storage region 94 storing the flight control data 40, the reference data 42, the self-device information 44, the other-device information 46, the exclusion information 48, the destination information 50, the target block information 52, and the direction change information 54.

The CPU 81 reads the flight control program 90 from the storage section 83, expands the flight control program 90 into the memory 82, and executes the processes included in the flight control program 90. The CPU 81 operates as the acquisition section 30 illustrated in FIG. 2 by executing the acquisition process 91. The CPU 81 operates as the determination section 32 illustrated in FIG. 2 by executing the determination process 92. The CPU 81 operates as the controller 34 illustrated in FIG. 2 by executing the control process 93. The computer 80 that executes the flight control program 90 thereby functions as the flight control device 12. Note that the CPU 81 that executes the processes included in the flight control program 90 is hardware.

Further, functionality implemented by the flight control program 90 may be implemented by, for example, a semiconductor circuit, or more specifically, by an application specific integrated circuit (ASIC) or the like.

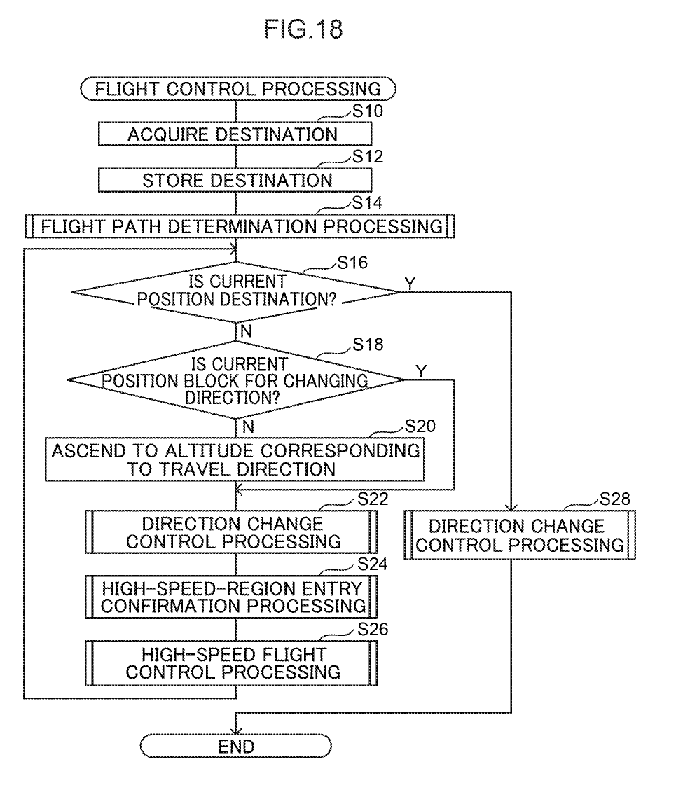

Next, operation of the flight control device 12 according to the present exemplary embodiment is described. The flight control processing illustrated in FIG. 18 is executed as a result of the flight control device 12 executing the flight control program 90. The flight control processing illustrated in FIG. 18 is executed by the CPU 81 when, for example, the latitude and longitude of the flight destination of the flying object 10 has been input by a user through a terminal or the like and an instruction to start flying has been input. Note that a case is described here in which the initial position of the flying object 10 is a position below an “ascend” voxel 62.

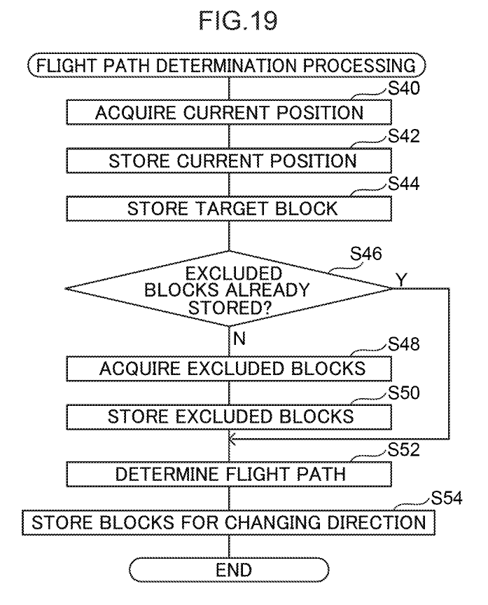

At step S10 of the flight control processing illustrated in FIG. 18, the acquisition section 30 acquires the latitude and longitude of the flight destination of the flying object 10 input by the user. At the next step S12, the acquisition section 30 stores the acquired latitude as the latitude of the destination information 50 and stores the acquired longitude as the longitude of the destination information 50. At the next step S14, the flight path determination processing illustrated in FIG. 19 is executed.

At step S40 of the flight path determination processing illustrated in FIG. 19, the acquisition section 30 acquires the latitude, longitude, and altitude of the current position of the flying object 10 from the GPS receiver 16. At the next step S42, the acquisition section 30 stores the latitude and longitude acquired at step S40 as the latitude and longitude of the self-device information 44. Further, the acquisition section 30 computes the south-north direction speed of the flying object 10 as described above. Further, the acquisition section 30 computes the east-west direction speed of the flying object 10 as described above.

Further, the acquisition section 30 computes the east-west direction coordinate and the south-north direction coordinate of the block 60 corresponding to the latitude and longitude acquired at step S40, with reference to the block 60 corresponding to the latitude and longitude of the reference data 42. Further, the acquisition section 30 computes the east-west direction coordinate and the south-north direction coordinate within the block 60 of the voxel 62 corresponding to the acquired latitude and longitude, based on the latitude and longitude of the reference data 42 and the latitude and longitude acquired at step S40. The acquisition section 30 then stores the computed south-north direction speed and east-west direction speed as the speed (latitudinal) and speed (longitudinal) of the self-device information 44. Further, the acquisition section 30 stores the computed east-west direction coordinate of the block 60, south-north direction coordinate of the block 60, east-west direction coordinate of the voxel 62, and south-north direction coordinate of the voxel 62 as the X-coordinate, the Y-coordinate, the x-coordinate, and the y-coordinate of the self-device information 44.

At the next step S44, the acquisition section 30 computes the east-west direction coordinate and south-north direction coordinate of the block 60 corresponding to the latitude and longitude of the destination information 50, with reference to the block 60 corresponding to the latitude and longitude of the reference data 42. The acquisition section 30 then stores the computed east-west direction coordinate and south-north direction coordinate as the X-coordinate and Y-coordinate of the target block information 52.

At the next step S46, the acquisition section 30 determines whether or not information related to blocks 60 that the flying object 10 is excluded from is stored in the exclusion information 48. Processing transitions to step S52 in cases in which the determination is an affirmative determination, or processing transitions to step S48 in cases in which the determination is a negative determination.

At step S48, the acquisition section 30 acquires, from the server 22, the X-coordinate and the Y-coordinate of the blocks 60 that the flying object 10 is excluded from, with reference to the block 60 corresponding to the latitude and longitude of the reference data 42. At the next step S50, the acquisition section 30 stores the X-coordinates and Y-coordinates acquired at step S48 as X-coordinates and Y-coordinates in the exclusion information 48.

At step S52, the determination section 32 refers to the self-device information 44, the exclusion information 48, and the target block information 52, and determines the flight path of the flying object 10 as described above. At the next step S54, the determination section 32 stores the travel direction for the flying object 10 after changing travel direction, as the direction in the direction change information 54 for blocks 60 on the flight path determined at step S52 in which the flying object 10 will change travel direction. The determination section 32 computes the east-west direction coordinates and south-north direction coordinates of the blocks 60 in which the flying object 10 will change travel direction on the flight path determined at step S52, with reference to the block 60 corresponding to the latitude and longitude of the reference data 42. The determination section 32 then stores the computed east-west direction coordinates and south-north direction coordinates as the X-coordinate and Y-coordinate of the direction change information 54. The flight path determination processing ends when the processing of step S54 ends. Processing transitions to step S16 when the flight path determination processing of step S14 illustrated in FIG. 18 ends.

At step S16 of the flight control processing illustrated in FIG. 18, the controller 34 determines whether or not the current position of the flying object 10 is within the region of the block 60 corresponding to the destination stored in the target block information 52. Processing transitions to step S18 in cases in which the determination is a negative determination.

At step S18, the controller 34 determines whether or not the current position of the flying object 10 is within the region of a block 60, stored in the direction change information 54, for changing travel direction. Processing transitions to step S22 in cases in which the determination is an affirmative determination, or processing transitions to step S20 in cases in which the determination is a negative determination.

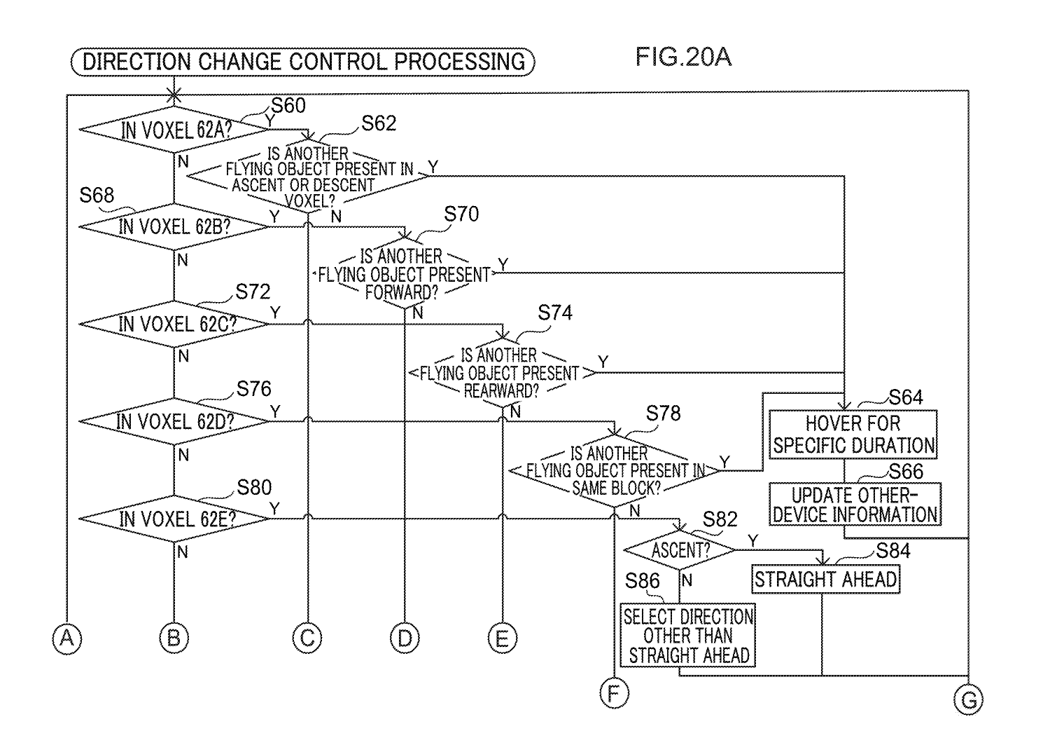

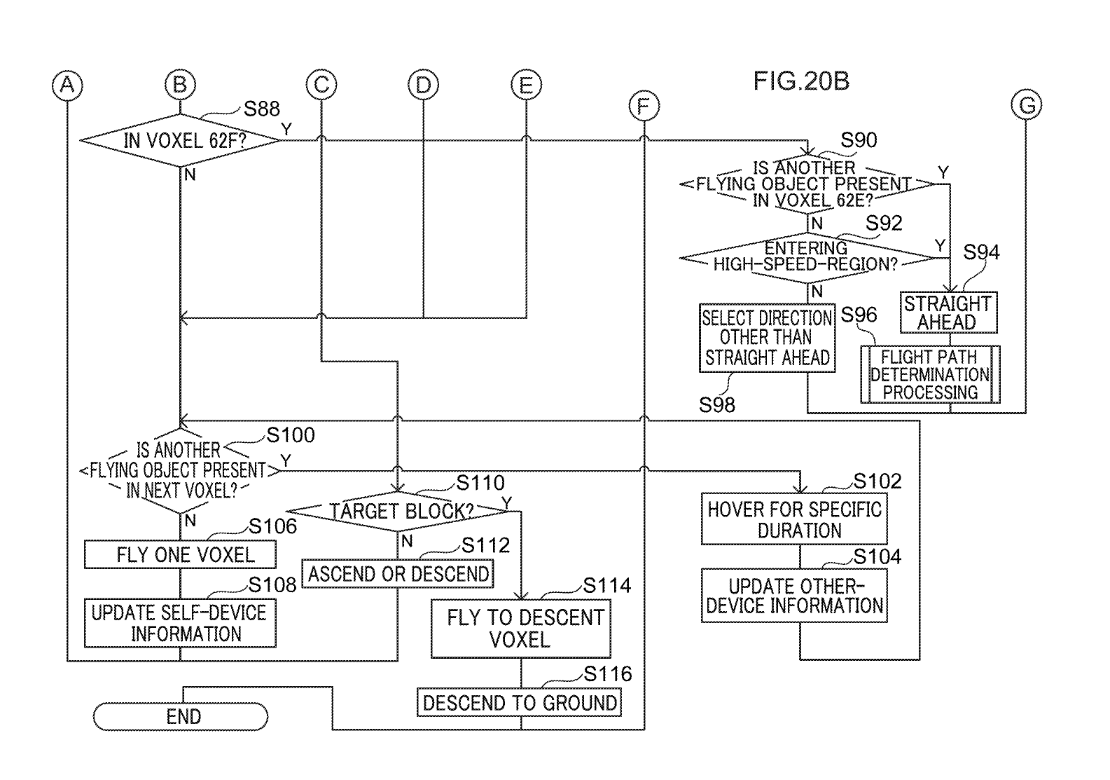

At step S20, the controller 34 controls the flying object 10 so as to make the flying object 10 climb to an altitude corresponding to the travel direction, based on the reference data 42 and the flight path determined at step S14. At the next step S22, the direction change control processing illustrated in FIG. 20A and FIG. 20B is executed.

At step S60 of the direction change control processing illustrated in FIG. 20A, the controller 34 determines whether or not the current position of the flying object 10 is within the region of the voxel 62A. Processing transitions to step S62 in cases in which the determination is an affirmative determination, or processing transitions to step S68 in cases in which the determination is a negative determination.

At step S62, the controller 34 refers to the other-device information 46 and determines whether or not another flying object 18 is present in the voxel 62 that the flying object 10 will enter next from out of the “ascend” and “descend” voxels 62 of the block 60 corresponding to the current position of the flying object 10. Processing transitions to step S64 in cases in which the determination is an affirmative determination, or processing transitions to step S110 in cases in which the determination is a negative determination.

At step S64, the controller 34 effects control so as to hover the flying object 10 for a specific duration (for example, 10 seconds). At step S66, the acquisition section 30 acquires various information from the other flying objects 18 present within the communicable range, as described above. The acquisition section 30 then uses the acquired various information to update the other-device information 46 as described above. Processing returns to step S60 when the processing of step S66 ends.

At step S68, the controller 34 determines whether or not the current position of the flying object 10 is within the region of the voxel 62B. Processing transitions to step S70 in cases in which the determination is an affirmative determination, or processing transitions to step S72 in cases in which the determination is a negative determination. At step S70, the controller 34 refers to the other-device information 46 and determines whether or not another flying object 18 is present in the voxels 62 spanning from the current position of the flying object 10 to a specific number (for example, two) of blocks forward in the travel direction of the flying object 10. Processing transitions to step S64 in cases in which the determination is an affirmative determination, or processing transitions to step S100 in cases in which the determination is a negative determination.

At step S72, the controller 34 determines whether or not the current position of the flying object 10 is in the region of the voxel 62C. Processing transitions to step S74 in cases in which the determination is an affirmative determination, or processing transitions to step S76 in cases in which the determination is a negative determination. At step S74, the controller 34 refers to the other-device information 46 and determines whether or not another flying object 18 is present in the region 67 of the block 60, spanning from the current position of the flying object 10 to a specific number (for example, two) of blocks rearward to the travel direction of the flying object 10. When making this determination, the controller 34 determines whether or not another flying object 18 is present in the region 67 of voxel layers at the same altitude as the voxel layer of the current position of the flying object 10. Processing transitions to step S64 in cases in which the determination is an affirmative determination, or processing transitions to step S100 in cases in which the determination is a negative determination.

At step S76, the controller 34 determines whether or not the current position of the flying object 10 is within the region of the voxel 62D. Processing transitions to step S78 in cases in which the determination is an affirmative determination, or processing transitions to step S80 in cases in which the determination is a negative determination. At step S78, the controller 34 determines whether or not another flying object 18 is present in the region 67 of the same voxel layer as that of the current position of the flying object 10. Processing transitions to step S64 in cases in which the determination is an affirmative determination, or the direction change control processing ends in cases in which the determination is a negative determination.

At step S80, the controller 34 determines whether or not the current position of the flying object 10 is within the region of the voxel 62E. Processing transitions to step S82 in cases in which the determination is an affirmative determination, or processing transitions to step S88 in cases in which the determination is a negative determination. At step S82, the controller 34 determines whether or not the flying object 10 is flying toward an “ascend” voxel 62. Processing transitions to step S84 in cases in which the determination is an affirmative determination, or processing transitions to step S86 in cases in which the determination is a negative determination.

At step S84, the controller 34 selects the direction in which the flying object 10 is proceeding straight ahead, namely, a direction toward an “ascend” voxel 62, and controls the flying object 10 so that the flying object 10 flies a single voxel 62 in the selected direction. Processing returns to step S60 when the processing of step S84 has ended. At step S86, the controller 34 selects a direction other than the direction in which the flying object 10 is proceeding straight ahead, namely, a direction toward a “descend” voxel 62, and controls the flying object 10 so that the flying object 10 flies a single voxel 62 in the selected direction. Processing returns to step S60 when the processing of step S86 has ended.

At step S88, the controller 34 determines whether or not the current position of the flying object 10 is within the region of the voxel 62F. Processing transitions to step S90 in cases in which the determination is an affirmative determination, or processing transitions to step S100 in cases in which the determination is a negative determination. At step S90, the controller 34 refers to the other-device information 46 and determines whether or not another flying object 18 is present in the voxel 62E adjacent to the voxel 62F of the current position of the flying object 10. Processing transitions to step S94 in cases in which the determination is an affirmative determination, or processing transitions to step S92 in cases in which the determination is a negative determination.

At step S92, the controller 34 determines whether or not the flying object 10 is flying so as to enter the region 67. Processing transitions to step S94 in cases in which the determination is an affirmative determination, or processing transitions to step S98 in cases in which the determination is a negative determination. At step S94, the controller 34 selects a direction that is straight ahead in the current travel direction of the flying object 10, and controls the flying object 10 so that the flying object 10 flies a single voxel 62 in the selected direction. At the next step S96, the flight path determination processing illustrated in FIG. 19 is executed. Processing returns to step S60 when the flight path determination processing of step S96 has ended.

At step S98, the controller 34 selects the direction other than the direction proceeding straight ahead in the travel direction of the flying object 10 at the current time, and controls the flying object 10 so that the flying object 10 flies a single voxel 62 in the selected direction. Processing returns to step S60 when the processing of step S98 has ended.

At step S100, the controller 34 refers to the other-device information 46 and determines whether or not another flying object 18 is present in the voxel 62 that will be next when the flying object 10 has flown a single voxel 62 in accordance with the travel direction defined by the voxel 62 of the current position of the flying object 10. Processing transitions to step S102 in cases in which the determination is an affirmative determination, or processing transitions to step S106 in cases in which the determination is a negative determination.

At step S102, similarly to at step S64, the controller 34 effects control so as to hover the flying object 10 for a specific duration. At the next step S104, similarly to at step S66, the acquisition section 30 updates the other-device information 46. Processing returns to step S100 when the processing of step S104 has ended. Note that processing may return to step S64 in cases in which the determination of step S100 was an affirmative determination.

At step S106, the controller 34 controls the flying object 10 so that the flying object 10 flies a single voxel 62 in accordance with the travel direction associated with the voxel 62 of the current position of the flying object 10. At the next step S108, the acquisition section 30 updates the self-device information 44 by performing processing similar to the processing of step S40 and step S42 of the flight path determination processing. Processing returns to step S60 when the processing of step S108 has ended. Note that at step S108, the acquisition section 30 may update the self-device information 44 under the assumption that the flying object 10 has flown a single voxel 62 (5 m in the present exemplary embodiment).

At step S110, the controller 34 determines whether or not the current position of the flying object 10 is within the region of the block 60 corresponding to the destination stored in the target block information 52. Processing transitions to step S112 in cases in which the determination is a negative determination, or processing transitions to step S114 in cases in which the determination is an affirmative determination.

At step S112, the controller 34 controls the flying object 10 so that the flying object 10 flies into an “ascend” or “descend” voxel 62 in accordance with the travel direction associated with the block 60 corresponding to the current position of the flying object 10. The controller 34 then controls the flying object 10 such that the flying object 10 flies a single voxel 62 after having ascended or descended to an altitude corresponding to the next travel direction of the flying object 10. Processing returns to step S60 when the processing of step S112 has ended.

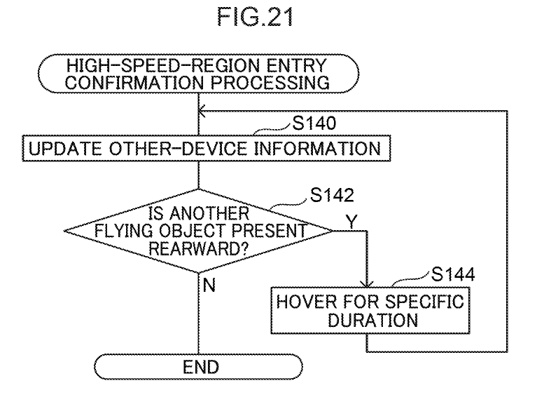

At step S114, the controller 34 controls the flying object 10 so that the flying object 10 flies to a “descend” voxel 62. At the next step S116, the controller 34 controls the flying object 10 so that the flying object 10 descends to the ground. The direction change control processing ends when the processing of step S116 has ended. When the direction change control processing of step S22 illustrated in FIG. 18 has ended, the high-speed-region entry confirmation processing illustrated in FIG. 21 is executed at the next step S24.

At step S140 of the high-speed-region entry confirmation processing illustrated in FIG. 21, the acquisition section 30 updates the other-device information 46, similarly to at step S66 of the direction change control processing. At step S142, the controller 34 refers to the other-device information 46 and determines whether or not another flying object 18 is present in the blocks 60 spanning from the block 60 corresponding to the current position of the flying object 10 to a specific number (for example, 2) of blocks 60 rearward with respect to the travel direction defined by the region 67 of the block 60. When making this determination, the controller 34 determines whether or not another flying object 18 is present in the voxel layer at the same altitude as the voxel layer corresponding to the altitude of the current position of the flying object 10 in the blocks 60 that span the specific number of blocks 60 rearward. Processing transitions to step S144 in cases in which the determination is an affirmative determination.

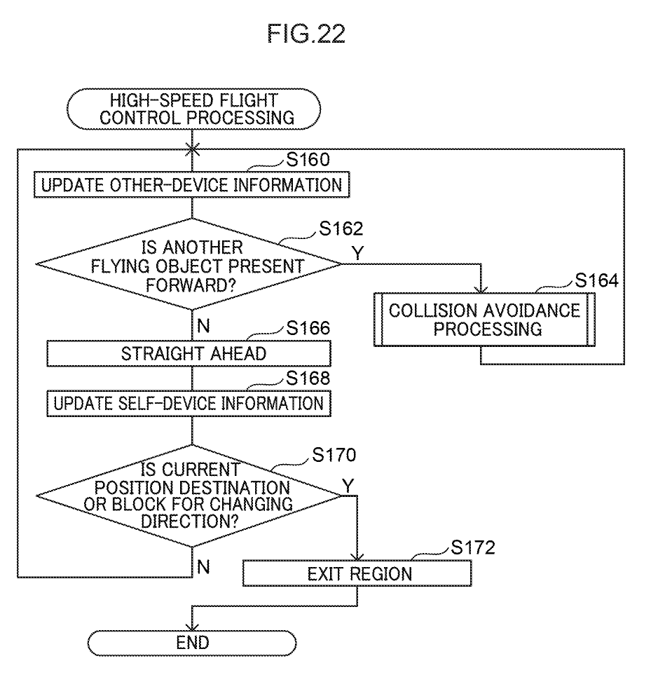

At step S144, the controller 34 controls the flying object 10 so as to hover the flying object 10 for a specific duration, similarly to in step S64 of the direction change control processing. Processing returns to step S140 when the processing of step S144 has ended. On the other hand, the high-speed-region entry confirmation processing ends in cases in which the determination of step S142 was a negative determination. When the high-speed-region entry confirmation processing of step S24 illustrated in FIG. 18 has ended, the high-speed flight control processing illustrated in FIG. 22 is executed at the next step S26.

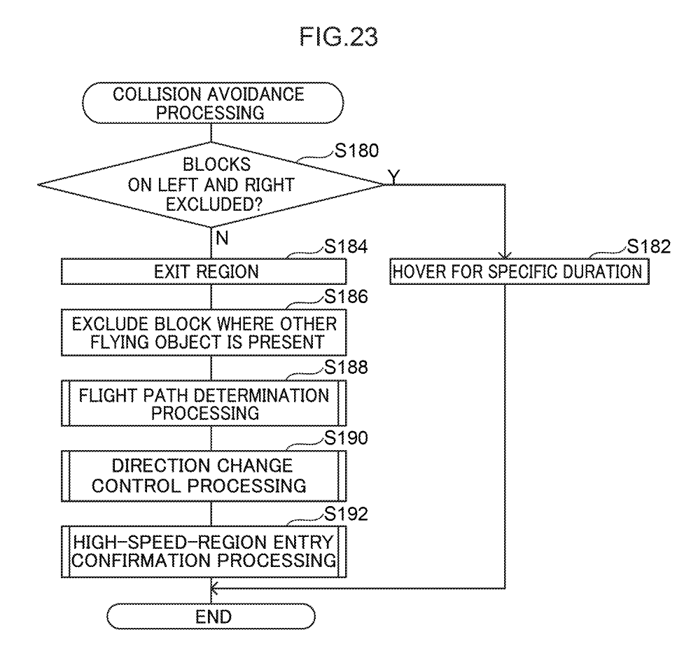

At step S160 of the high-speed flight control processing illustrated in FIG. 22, the acquisition section 30 updates the other-device information 46, similarly to in step S66 of the direction change control processing. At step S162, the controller 34 refers to the other-device information 46 and determines whether or not another flying object 18 is present within the blocks 60 spanning from the block 60 corresponding to the current position of the flying object 10 to a specific number (for example, two) of blocks 60 forward with respect to the travel direction defined by the region 67 of the block 60. When making this determination, the controller 34 determines whether or not another flying object 18 is present in a voxel layer of the same altitude as the voxel layer corresponding to the altitude of the current position of the flying object 10 within the blocks 60 that span the specific number of blocks 60 forward. Processing transitions to step S164 in cases in which the determination is an affirmative determination. At step S164, the collision avoidance processing illustrated in FIG. 23 is executed.

At step S180 of the collision avoidance processing illustrated in FIG. 23, the controller 34 makes a determination as follows. Namely, the controller 34 refers to the exclusion information 48 and determines whether or not both of the blocks 60 that are adjacent to the left and right with respect to the travel direction of the region 67 of the block 60 corresponding to the current position of the flying object 10 are blocks 60 that the flying object 10 is excluded from. Processing transitions to step S182 in cases in which the determination is an affirmative determination, or processing transitions to step S184 in cases in which the determination is a negative determination.

At step S182, the controller 34 controls the flying object 10 so as to hover the flying object 10 for a specific duration, similarly to in step S64 of the direction change control processing. The collision avoidance processing ends when the processing of step S182 has ended.

On the other hand, at step S184, the controller 34 controls the flying object 10 so that the flying object 10 proceeds straight ahead to the voxel 62G. At the voxel 62Q the controller 34 then selects a direction for exiting the region 67 and controls the flying object 10 so that the flying object 10 flies a single voxel 62 in the selected direction. At the next step S186, the acquisition section 30 stores, in the exclusion information 48, information related to the block 60 the other flying object 18 was determined to be present in, from out of the blocks 60 that span the specific number forward of step S162 of the high-speed flight control processing.

At the next step S188, the flight path determination processing illustrated in FIG. 19 is executed. When the flight path determination processing of step S188 has ended, the direction change control processing illustrated in FIG. 20A and FIG. 20B is executed at the next step S190. When the direction change control processing of step S190 has ended, the high-speed-region entry confirmation processing illustrated in FIG. 21 is executed at the next step S192. The collision avoidance processing ends when the high-speed-region entry confirmation processing of step S192 has ended.

Processing returns to step S160 when the collision avoidance processing of step S164 illustrated in FIG. 22 has ended. On the other hand, processing transitions to step S166 in cases in which the determination of step S162 of the high-speed flight control processing illustrated in FIG. 22 is a negative determination.

At step S166, the controller 34 controls the flying object 10 so that the flying object 10 flies a single voxel 62 in the direction that flying object 10 is proceeding straight ahead in. At step S168, the acquisition section 30 updates the self-device information 44 by performing processing similar to the processing of step S40 and step S42 of the flight path determination processing.

At step S170, the controller 34 determines whether or not the current position of the flying object 10 is within the region of the block 60 corresponding to the destination stored in the target block information 52, or within the region of a block 60 in which the flying object 10 will change travel direction stored in the direction change information 54. Processing returns to step S160 in cases in which the determination is a negative determination, or processing transitions to step S172 in cases in which the determination is an affirmative determination.

At step S172, the controller 34 controls the flying object 10 so that the flying object 10 proceeds straight ahead to the voxel 62Q similarly to in step S184 of the collision avoidance processing. The controller 34 then selects a direction for exiting the region 67 at the voxel 62G and controls the flying object 10 so that the flying object 10 flies a single voxel 62 in the selected direction. The high-speed flight control processing ends when the processing of step S172 has ended.

Processing returns to step S16 when the high-speed flight control processing of step S26 illustrated in FIG. 18 has ended. On the other hand, processing transitions to step S28 in cases in which the determination of step S16 of the flight control processing illustrated in FIG. 18 was an affirmative determination. At step S28, the direction change control processing illustrated in FIG. 20A and FIG. 20B is executed. The flight control processing ends when the direction change control processing of step S28 has ended.

As described above, according to the present exemplary embodiment, the storage section 83 that stores information related to the flight control in association with the voxels 62 is referred to, and information related to flight control corresponding to a specific voxel 62 is acquired. Then, according to the present exemplary embodiment, the flight of the flying object 10 is controlled based on the acquired information related to the flight control. Accordingly, flying objects can be moved smoothly in cases in which plural flying objects are flying within a specific area.

Further, according to the present exemplary embodiment, the travel direction is predetermined based on the altitude of the voxel 62. Accordingly, flying objects can be moved smoothly in cases in which plural flying objects are flying within a specific area. Further, in cases in which the flying object 10 is flying in a horizontal flight plane, and not in other cases in which the flying object 10 is ascending or descending, and in cases in which confirmation is to be made as to whether or not another flying object 18 is present in the surroundings of the flying object 10, confirmation is made as to whether or not another flying object 18 is present in a voxel layer at the same altitude. Accordingly, the number of other flying objects 18 whose presence or absence is to be confirmed within the surroundings of the flying object 10 can be reduced.

Note that in the present exemplary embodiment, although a case in which the voxel 62 is defined by coordinates was described, there is no limitation thereto. For example, the voxel 62 may be defined by a latitude, a longitude, and an altitude. Further, for example, the voxel 62 may be defined by a combination of coordinates and at least one out a latitude, a longitude, and an altitude.

Further, in the present exemplary embodiment, although a mode in which the flight control program 90 is pre-stored (installed) on the storage section 83 has been described, there is no limitation thereto. The flight control program 90 may be provided in a format recorded to a non-transitory recording medium such as a CD-ROM, a DVD-ROM, USB memory, a memory card, or the like.

According to the related art, for example, in cases in which a flying object that flies autonomously is employed in a delivery system or the like, numerous flying objects could conceivably fly within a specific area. In such cases, a flying object could conceivably detect that another flying object is flying within a specific distance from itself, and avoid a collision with the other flying object.

However, within an area where numerous flying objects are flying, there are cases in which a direction taken by the flying object to avoid the other flying object is a direction where yet another flying object is flying, and in such cases the number of times the flying object changes direction to avoid other flying objects is a large number of times. The flying object is accordingly unable to fly smoothly in such cases.

According to an aspect of the present disclosure, a flying object moves smoothly in cases in which plural flying objects are flying within a specific area.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A flight control method comprising:
by a processor,
referring to a storage section that stores information related to flight control in association with airspace area, and acquiring information related to flight control corresponding to a specified airspace area; and
controlling flight of a subject device based on the acquired information related to flight control.

2. The flight control method of claim 1, wherein the specified airspace area is an area corresponding to a position in airspace of the subject device.

3. The flight control method of claim 1, wherein the information related to flight control is a travel direction or a hover control.

4. The flight control method of claim 1, wherein the information related to flight control is one or more travel directions.

5. The flight control method of claim 1, wherein:
the information related to flight control is a plurality of travel directions; and
a travel direction enabling a collision to be avoided is selected from the plurality of travel directions, in accordance with a detected direction of another flying object.

6. The flight control method of claim 1, wherein the storage section stores information related to flight control in association with a plurality of mesh-partitioned airspace areas.

7. The flight control method of claim 1, wherein the airspace area is defined according to one or more of a latitude, a longitude, or an altitude.

8. The flight control method of claim 1, wherein, in the information related to flight control, a travel direction is predetermined in accordance with an altitude corresponding to the airspace area.

9. A non-transitory recording medium storing a flight control program that causes a computer to execute processing, the processing comprising:
referring to a storage section that stores information related to flight control in association with airspace area, and acquiring information related to flight control corresponding to a specified airspace area; and
controlling flight of a subject device based on the acquired information related to flight control.

10. The non-transitory recording medium of claim 9, wherein the specified airspace area is an area corresponding to a position in airspace of the subject device.

11. The non-transitory recording medium of claim 9, wherein the information related to flight control is a travel direction or a hover control.

12. The non-transitory recording medium of claim 9, wherein the information related to flight control is one or more travel directions.

13. The non-transitory recording medium of claim 9, wherein:
the information related to flight control is a plurality of travel directions; and
the processing selects a travel direction enabling a collision to be avoided from the plurality of travel directions, in accordance with a detected direction of another flying object.

14. The non-transitory recording medium of claim 9, wherein the storage section stores information related to flight control in association with a plurality of mesh-partitioned airspace areas.

15. The non-transitory recording medium of claim 9, wherein the airspace area is defined according to one or more of a latitude, a longitude, or an altitude.

16. The non-transitory recording medium of claim 9, wherein, in the information related to flight control, a travel direction is predetermined in accordance with an altitude corresponding to the airspace area.

17. A flight control device, comprising:
a memory that stores information related to flight control in association with airspace area; and
a processor coupled to the memory, the processor being configured to:
refer to the memory and acquire information related to flight control corresponding to a specified airspace area; and
control flight of a subject device based on the acquired information related to flight control.

18. The flight control device of claim 17, wherein the specified airspace area is an area corresponding to a position in airspace of the subject device.

19. The flight control device of claim 17, wherein the information related to flight control is a travel direction or a hover control.

20. The flight control device of claim 17, wherein the information related to flight control is one or more travel directions.

21. The flight control device of claim 17, wherein:
the information related to flight control is a plurality of travel directions; and
the processor is configured so as to select a travel direction enabling a collision to be avoided from the plurality of travel directions, in accordance with a detected direction of another flying object.

22. The flight control device of claim 17, wherein the memory stores information related to flight control in association with a plurality of mesh-partitioned airspace areas.

23. The flight control device of claim 17, wherein the airspace area is defined according to one or more of a latitude, a longitude, or an altitude.

24. The flight control device of claim 17, wherein, in the information related to flight control, a travel direction is predetermined in accordance with an altitude corresponding to the airspace area.
